(19) United States
(12) Patent Application Publication
(10) Pub. No.: US 2008/0261548 A1
(43) Pub. Date: Oct. 23, 2008

(54) SYSTEM AND METHOD FOR SELECTING AN INTERMEDIATE FREQUENCY

(76) Inventor: Andrew W. Krone, Austin, TX (US)

Correspondence Address: DICKE, BILLIG & CZAJA, PLLC;ATTN: SILABS MATTERS, FIFTH STREET TOWERS, SUITE 2250, 100 SOUTH FIFTH STREET, MINNEAPOLIS, MN, 55402, US

(21) Appl. No.: 11/737,366

(22) Filed: Apr. 19, 2007

(51) Int. Cl. H04B 1/16; H04B 1/18

(52) U.S. Cl. 455/205; 455/150.1

(57) ABSTRACT

A receiver including a mixer configured to generate a mixed signal at a first intermediate frequency from an input signal and a mixing signal and processing circuitry configured to detect a power level for each of a plurality of possible images in the mixed signal and configured to cause the mixer to generate the mixed signal at a second intermediate frequency that differs from the first intermediate frequency and corresponds to an image frequency of one of the plurality of possible images with a lowest of the power level is provided.

### BACKGROUND

Radio frequency (RF) receivers are used in a wide variety of applications such as cellular or mobile telephones, cordless telephones, personal digital assistants (PDAs), computers, radios and other devices that transmit or receive RF signals. As receivers become increasingly integrated and more portable, the efficiency receiving an input signal tends to increase in importance.

Modern receivers often mix a target channel to an intermediate frequency using a mixing signal. As a result of the mixing, an undesired image occurs at an image frequency that can interfere with the target channel. The undesired image can be particularly troublesome where strong spectral content is present at the image frequency. Accordingly, it would be desirable to minimize any interference from a undesired image to maximize the signal selectivity and minimize the signal-to-noise ratio of target channel in a receiver.

### SUMMARY

According to one exemplary embodiment, a receiver including a mixer configured to generate a mixed signal at a first intermediate frequency from an input signal and a mixing signal and processing circuitry configured to detect a power level for each of a plurality of possible images in the mixed signal and configured to cause the mixer to generate the mixed signal at a second intermediate frequency that differs from the first intermediate frequency and corresponds to an image frequency of one of the plurality of possible images with a lowest of the power level is provided.

In another exemplary embodiment, a method performed by a low intermediate frequency receiver is provided. The method includes determining a first power level of a first image in a mixed signal having a first intermediate frequency and selecting a second intermediate frequency for the mixed signal in response to the first power level exceeding a desired power level.

In further exemplary embodiment, a system comprising means for detecting a first power level of a first image in a mixed signal generated from an input signal and a mixing signal, the first image corresponding to a first intermediate frequency of the mixed signal, and means for changing the mixed signal to a second intermediate frequency that differs from the first intermediate frequency in response to the first power level exceeding a threshold level is provided.

In yet another exemplary embodiment, a system comprising an audio output interface configured to provide an output signal to a listening device and a receiver is provided. The receiver includes a mixer configured to generate a mixed signal at a first intermediate frequency from an input signal and a mixing signal and processing circuitry configured to detect a power level for each of a plurality of possible images in the mixed signal and configured to cause the mixer to generate the mixed signal at a second intermediate frequency that differs from the first intermediate frequency and corresponds to an image frequency of one of the plurality of possible images with a lowest of the power level. The receiver is configured to generate the output signal from a target channel in the mixed signal and provide the output signal to the audio output interface.

### BRIEF DESCRIPTION OF THE DRAWINGS

FIGS. 1A-1C are block diagrams illustrating embodiments of a low intermediate frequency (low-IF) receiver.

FIG. 2 is a graphical diagram illustrating one embodiment of mixing signals in a low-IF receiver.

FIGS. 3A-3B are block diagrams illustrating embodiments of selected portions of processing circuitry in a low-IF receiver.

FIGS. 4A-4B are graphical diagrams illustrating an example of selecting an intermediate frequency in a low-IF receiver.

FIG. 5 is a block diagram illustrating one embodiment of a device that includes a low-IF receiver.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

As described herein, an integrated low power, low intermediate frequency (low-IF) receiver is provided for use in receiving radio-frequency (RF) signals or signals from other frequency bands. The receiver is configured to minimize interference from an undesired image that results from mixing a target channel to an intermediate frequency (IF). To do so, the receiver selects an IF that corresponds to an undesired image with the lowest power. The receiver analyzes the power levels at possible image frequencies for a given target channel (i.e., image frequencies corresponding to different IFs), determines the image frequency with the lowest power image, and sets the IF so that the undesired image occurs at the image frequency with the lowest power.

The low-IF receivers described herein may be used in a wide variety of integrated communications systems. Although terrestrial RF receivers, e.g., FM and AM receivers, are described herein, these receivers are presented by way of example. In other embodiments, other frequency bands may be used.

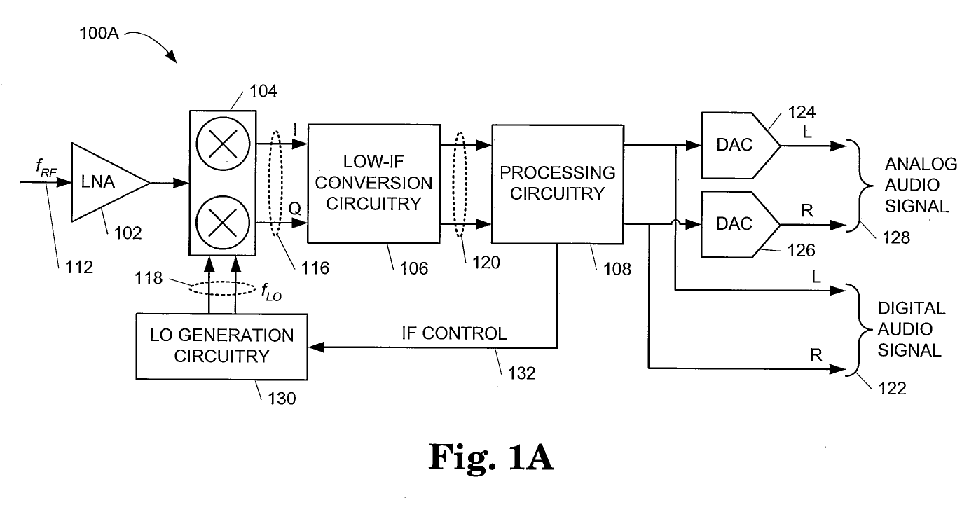

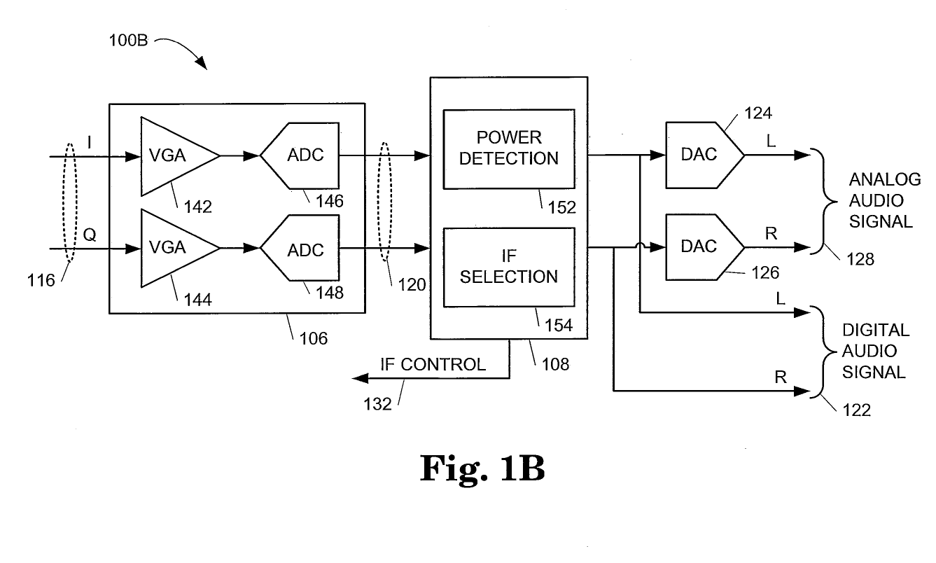

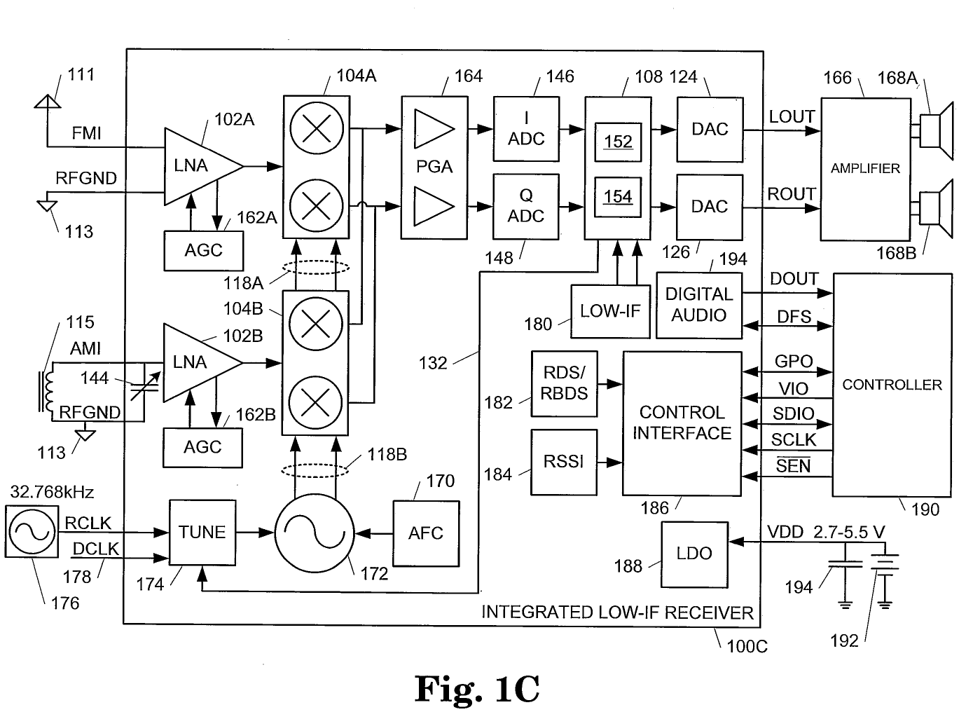

FIG. 1A is a block diagram illustrating an embodiment 100A of a low intermediate frequency (low-IF) receiver 100. Receiver 100A includes a low noise amplifier (LNA) 102, a mixer 104, low intermediate frequency (IF) conversion circuitry 106, processing circuitry 108, digital-to-analog converters 124 and 126, and local oscillator generation circuitry 130.

Receiver 100A is configured to receive a radio-frequency (RF) signal spectrum 112 and process signal spectrum 112 to generate a digital audio signal 122 and an analog audio signal 128 using a low intermediate frequency (IF) architecture. In one embodiment, receiver 100A forms an integrated terrestrial broadcast receiver configured to receive radio-frequency (RF) signals. As used herein, an RF signal means an electrical signal conveying useful information and having a frequency from about 3 kilohertz (kHz) to thousands of gigahertz (GHz), regardless of the medium through which the signal is conveyed. Thus, an RF signal may be transmitted through air, free space, coaxial cable, and/or fiber optic cable, for example. In other embodiments, receiver 100A may be configured to receive signals 112 in another suitable frequency range.

In one embodiment, receiver 100A is configured as an AM/FM terrestrial broadcast receiver. In this embodiment, signal spectrum 112 includes the AM/FM terrestrial broadcast spectrum with a plurality of different AM and FM broadcast channels that are centered at different broadcast frequencies. In other embodiments, receiver 100A may be configured as a terrestrial broadcast receiver where signal spectrum 112 includes other terrestrial broadcast spectra with other channels.

LNA 102 receives RF signal spectrum 112 and generates an amplified output signal. The output of LNA 102 is then applied to mixer 104, and mixer 104 generates real (I) and imaginary (Q) output signals, as represented by signals 116. To generate low-IF signals 116, mixer 104 uses phase shifted local oscillator (LO) mixing signals 118. LO generation circuitry 130 includes oscillation circuitry (not shown) and outputs two out-of-phase LO mixing signals 118 that are used by mixer 104. The outputs of mixer 104 are at a low-IF, which is set according to a control signal 132 from processing circuitry 108 as will be described in additional detail below.

Low-IF conversion circuitry 106 receives the real (I) and imaginary (Q) signals 116 and outputs real and imaginary digital signals, as represented by signals 120. Low-IF conversion circuitry 106 preferably includes band-pass or low-pass analog-to-digital converter (ADC) circuitry that converts the low-IF input signals to the digital domain. Low-IF conversion circuitry 106 provides, in part, analog-to-digital conversion, signal gain, and signal filtering functions. Low-IF conversion circuitry 106 provides signals 120 to processing circuitry 108.

Processing circuitry 108 performs digital filtering and digital signal processing to further tune and extract the signal information from digital signals 120. Processing circuitry 108 produces baseband digital audio output signals 122. When the input signals relate to FM broadcasts, the digital processing provided by processing circuitry 108 may include, for example, FM demodulation and stereo decoding. Digital output signals 122 may include left (L) and right (R) digital audio output channels that represent the content of the FM broadcast channel being tuned. Processing circuitry 108 also provides the left and right digital audio output channels of signals 122 to DACs 124 and 126, respectively.

DACs 124 and 126 receive the left and right digital audio output channels of signals 122, respectively, and convert digital signals 122 to analog audio output signals 128 with left and right analog audio output channels.

In other embodiments, the output of receiver 100A may be other desired signals, including, for example, low-IF quadrature I/Q signals from an analog-to-digital converter that are passed through a decimation filter, a baseband signal that has not yet be demodulated, multiplexed L+R and L−R audio signals, and/or any other desired output signals.

As used herein, low-IF conversion circuitry refers to circuitry that in part mixes the target channel within the input signal spectrum down to an IF that is equal to or below about three channel widths. For example, for FM broadcasts within the United States, the channel widths are about 200 kHz. Thus, broadcast channels in the same broadcast area are specified to be at least about 200 kHz apart. For the purposes of this description, therefore, a low IF frequency for FM broadcasts within the United States would be an IF frequency equal to or below about 600 kHz. It is further noted that for spectrums with nonuniform channel spacings, a low IF frequency would be equal to or below about three steps in the channel tuning resolution of the receiver circuitry. For example, if the receiver circuitry were configured to tune channels that are at least about 100 kHz apart, a low IF frequency would be equal to or below about 300 kHz.

For purposes of illustration, input signals 112 of receiver 100A described herein may be received in signal bands such as AM audio broadcast bands, FM audio broadcast bands, television audio broadcast bands, weather channel bands, or other desired broadcast bands. The following table provides example frequencies and uses for various broadcast bands that may be received by receiver 100A.

TABLE 1
EXAMPLE FREQUENCY BANDS AND USES

| FREQUENCY | | USES/SERVICES |
|---|---|---|
| 150–535 | kHz | European LW radio broadcast |
| | | 9 kHz spacing |
| 535–1700 | kHz | MW/AM radio broadcast |
| | | U.S. uses 10 kHz spacing |
| | | Europe uses 9 kHz spacing |
| 1.7–30 | MHz | SW/HF international radio broadcasting |
| 46–49 | MHz | Cordless phones, baby monitors, remote control |
| 59.75 (2) | MHz | U.S. television channels 2–6 (VHF_L) |
| 65.75 (3) | MHz | 6 MHz channels at 54, 60, 66, 76, 82 |
| 71.75 (4) | MHz | Audio carrier is at 5.75 MHz (FM MTS) |
| 81.75 (5) | MHz | |
| 87.75 (6) | MHz | |
| 47–54 (E2) | MHz | European television |
| 54–61 (E3) | MHz | 7 MHz channels, FM sound |
| 61–68 (E4) | MHz | Band I: E2–E4 |
| 174–181 (E5) | MHz | Band II: E5–E12 |
| 181–188 (E6) | MHz | |
| 188–195 (E7) | MHz | |
| 195–202 (E8) | MHz | |
| 202–209 (E9) | MHz | |
| 209–216 (E10) | MHz | |
| 216–223 (E11) | MHz | |
| 223–230 (E12) | MHz | |
| 76–91 | MHz | Japan FM broadcast band |
| 87.9–108 | MHz | U.S./Europe FM broadcast band |
| | | 200 kHz spacing (U.S.) |
| | | 100 kHz spacing (Europe) |
| 162.550 (WX1) | MHz | U.S. Weather Band |
| 162.400 (WX2) | MHz | 7 channels, 25 kHz spacing |
| 162.475 (WX3) | MHz | SAME: Specific Area Message Encoding |
| 162.425 (WX4) | MHz | |
| 162.450 (WX5) | MHz | |
| 162.500 (WX6) | MHz | |
| 162.525 (WX7) | MHz | |
| 179.75 (7) | MHz | U.S. television channels 7–13 (VHF_High) |
| | | 6 MHz channels at 174, 180, 186, 192, 198, |
| | | 204, 210 |
| 215.75 (13) | MHz | FM Sound at 5.75 MHz |
| 182.5 (F5) | MHz | French television F5–F10 Band III |
| | | 8 MHz channels |
| 224.5 (F10) | MHz | Vision at 176, 184, 192, 200, 208, 216 MHz |
| | | AM sound at +6.5 MHz |
| 470–478 (21) | MHz | Band IV —television broadcasting |
| | | Band V —television broadcasting |
| 854–862 (69) | MHz | 6 MHz channels from 470 to 862 MHz |
| | | U.K. System I (PAL): |
| | | Offsets of +/−25 kHz may be used to alleviate co- |
| | | channel interference |
| | | AM Vision carrier at +1.25 (Lower Sideband |
| | | vestigial) |
| | | FMW Sound carrier at +7.25 |
| | | Nicam digital sound at +7.802 |
| | | French System L (Secam): |
| | | Offsets of +/−37.5 kHz may be used |
| | | AM Vision carrier at +1.25 (inverted video) |
| | | FMW Sound carrier at +7.75 |
| | | Nicam digital sonnd at +7.55 |
| 470–476 (14) | MHz | U.S. television channels 14–69 |
| | | 6 MHz channels |
| 819–825 (69) | MHz | Sound carrier is at 5.75 MHz (FM MTS) |
| | | 14–20 shared with law enforcement |

In receiver 100A, LO generation circuitry 130 outputs local oscillator mixing signals 118 in the form of a sine wave or other periodic wave with a tuned frequency, f_{LO}, to mixer 104. Mixer 104 mixes RF signal spectrum 112, which includes desired spectral content at a target channel having a particular center frequency, f_{CH}, with mixing signals 118 to form signals 116 with spectral components at frequencies equal to the sum and the difference of the two input frequencies (i.e., f_{CH}+f_{LO} and f_{CH}−f_{LO}). One of these components forms the channel center frequency translated to the intermediate frequency, f_{IF}, and the other component may be filtered out.

In one embodiment, mixer 104 implements high-side injection such that the intermediate frequency, f_{IF}, is determined from the equation f_{LO}−f_{CH}=f_{IF}. In this embodiment, mixer 104 also mixes an undesired image at an image frequency, f_{IMAGE}, that is determined from the equation f_{LO}+f_{IF}=f_{IMAGE}. In another embodiment, mixer 104 implements low-side injection such that the intermediate frequency, f_{IF}, is determined from the equation f_{CH}−f_{LO}=f_{IF}. In this embodiment, mixer 104 also mixes an undesired image at an image frequency, f_{IMAGE}, that is determined from the equation f_{LO}−f_{IF}=f_{IMAGE}.

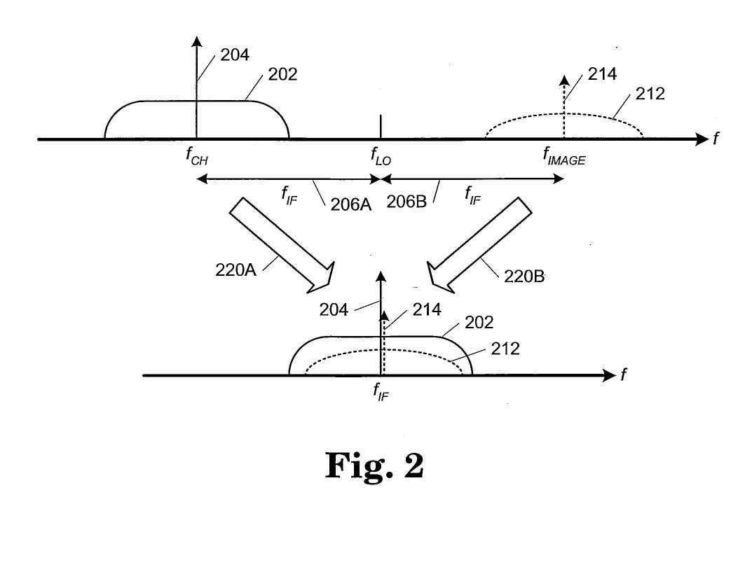

When mixer 104 mixes RF signal spectrum 112 with mixing signals 118 using either low-side or high-side injection, mixer 104 combines an undesired image 212 onto desired spectral content 202 in signals 116 as shown in the graphical diagram of FIG. 2 which illustrates an example of high-side injection. The desired spectral content 202 of the target channel occurs at the center frequency, f_{CH}, 204 and the undesirable image 212 occurs at the image frequency, f_{IMAGE}, 214. The center frequency, f_{CH}, 204 and the image frequency, f_{IMAGE}, 214 are each separated from the tuned frequency, f_{LO}, of LO generation circuitry 130 by the intermediate frequency, f_{IF}, as indicated by arrows 206A and 206B. By mixing RF signal spectrum 112 with mixing signals 118, mixer 104 combines undesired image 212 onto desired spectral content 202 in signals 116 at the intermediate frequency (IF), f_{IF}, as indicated by arrows 220A and 220B. Although components such as LNA 102 and mixer 104 may provide some image rejection, these components may not fully prevent undesired image 212 from interfering with desired spectral content 202.

To minimize any interference from an undesired image, receiver 100A selects an IF that corresponds to undesired image with the lowest power. In receiver 100A, processing circuitry 108 analyzes the power levels at possible image frequencies, f_{IMAGE}, for a given target channel (i.e., image frequencies corresponding to different IFs), determines the image frequency with the lowest power level, and sets the tuned frequency, f_{LO}, of LO generation circuitry 130 using IF control signal 132 so that the undesired image occurs at the image frequency with the lowest power. By setting the tuned frequency, f_{LO}, processing circuitry 108 sets the intermediate frequency, f_{IF}, of signals 116 and signals 120 to a selected IF that varies based on the lowest power image frequency.

FIG. 1B is a block diagram illustrating an embodiment 100B of receiver 100. In receiver 100B, low-IF conversion circuitry 106 includes variable gain amplifiers (VGAs) 142 and 144 and analog-to-digital converters 146 and 148. Processing circuitry 108 includes a power detection unit 152 and an IF selection unit 154.

VGAs 142 and 144 receive the real (I) and imaginary (Q) signals 116, respectively, that have been mixed down to a low-IF frequency by mixer 104 and amplify signals 116. Band-pass ADC 146 converts the output of VGA 142 from low-IF to the digital domain to produce the real (I) portion of digital output signals 120, and band-pass ADC 148 converts the output of VGA 144 from low-IF to the digital domain to produce the imaginary (Q) portion of digital output signals 120. In other embodiments, ADCs 156 and 158 may be implemented as complex band-pass ADCs, real low-pass ADCs, or any other desired ADC architecture.

Processing circuitry 108 receives signals 120 from ADCs 146 and 148 and digitally processes signals 120 to further tune the target channel using a channel selection filter (not shown). Processing circuitry 108 may also provide FM demodulation of the tuned digital signals and stereo decoding, such as MPX decoding. In addition, processing circuitry 108 may tune and decode RDS (Radio Data System) and/or RBDS (radio broadcast data System) information using in part a RDS/RBDS decoder (shown as a RDS/RBDS block 182 in FIG. 1C) within processing circuitry 108. Processing circuitry 108 outputs left (L) and right (R) digital audio signals 122. Integrated DACs 124 and 126 convert digital audio signals 122 to left (L) and right (R) analog audio signals 128.

In receiver 100B, ADCs 146 and 148 have sufficient bandwidth to allow for the use of various IFs in at least one mode of operation. In one embodiment, ADCs 146 and 148 have a bandwidth from 28 kHz to 228 kHz (i.e., 200 kHz) to allow for reception of FM channels. Because AM channels are generally 9 or 10 kHz wide, various IFs may be used during AM reception while ensuring that the desired signal spectrum remains within the bandwidth of ADCs 146 and 148 in this embodiment. For example, if the target channel frequency is 1000 kHz, then the frequency of mixing signal 118 may be set anywhere between 772 kHz (i.e., 1000-228 kHz) and 972 kHz (i.e., 1000-28 kHz). Accordingly, the IF would be between 28 kHz (i.e., 1000-972 kHz) and 228 kHz (i.e., 1000-772 kHz) and the image frequency would be between 544 kHz (i.e., 1000−(2×228 kHz)) and 944 kHz (i.e., 1000−(2×28 kHz)) depending on the frequency of mixing signal 118.

Additional details of selecting an IF based on an image frequency with the lowest power image will now be described. In processing circuitry 108, power detection unit 152 analyzes the power levels of possible image frequencies for a given target channel where each image frequency corresponds to a different IF. Power detection unit 152 determines the image frequency with the lowest power. IF selection unit 154 sets the tuned frequency, f_{LO}, of LO generation circuitry 130 using IF control signal 132 so that the undesired image occurs at the image frequency with the lowest power. By setting the tuned frequency, f_{LO}, IF selection unit 154 sets the intermediate frequency, f_{IF}, of signals 116 and signals 120 to a selected IF that varies based on the lowest power image frequency.

In one embodiment, IF selection unit 154 sets the tuned frequency, f_{LO}, of LO generation circuitry 130 using IF control signal 132 based on the channel spacing, f_{SPACE}, of a channelized reception application such as AM broadcast reception. In this embodiment, IF selection unit 154 sets the tuned frequency, f_{LO}, to cause the image frequency to occur at an integer multiple, M, of channels away from the target channel frequency, f_{CH}, as shown in Equation I.

f_{IMAGE}=f_{CH}±(M×f_{SPACE}) Equation I

Accordingly, power detection unit 152 analyzes the power levels of possible image frequencies that are at integer multiples of the channel spacing from the target channel frequency and determines the image frequency with the lowest power in this embodiment. The image frequency at each integer multiple of the channel spacing corresponds to a different IF. IF selection unit 154 sets the IF by selecting the integer multiple of the lowest power image and setting the mixing signal frequency, f_{LO}, as shown in Equation II.

$${f}_{IF} = \vert {f}_{LO} - {f}_{CH} \vert = ( \frac{M}{2} ) \times {f}_{SPACE} \qquad Equation II$$

In one example, the channel spacing is 10 kHz and the integer multiple, M, is set to 9, ±3, (i.e., a range from 6 to 12). In this example, the IF will be set to the one of seven possible image frequencies between 30 kHz (i.e., M=6) and 60 kHz (i.e., M=12) that has the lowest power image.

In another example where the channel spacing is 9 kHz and the integer multiple, M, is set to 10, ±3, (i.e., a range from 7 to 13). In this example, the IF will be set to the one of seven possible image frequencies between 31.5 kHz (i.e., M=6) and 58.5 kHz (i.e., M=12) that has the lowest power image.

In another embodiment, IF selection unit 154 sets the tuned frequency, f_{LO}, of LO generation circuitry 130 using IF control signal 132 to be halfway between the target channel frequency and the image frequency with the lowest power without regard to the channel spacing. In this embodiment, processing circuitry 108 may perform additional processing to compensate for undesirable tones that may appear in the target spectrum of mixed signal 120 where receiver 100B is used in a channelized reception application such as AM broadcast reception.

Processing circuitry 108 may analyze the power levels of one or more possible images of a target channel and select an IF corresponding to the lowest power image continuously or periodically at any suitable time during operation. For example, processing circuitry 108 may analyze a range or a discrete set of power levels and select an IF in response to a target channel being selected. A target channel may be selected when receiver 100B is powered on or reset (e.g., using a stored channel selection of a previously tuned channel) or when a channel selection is changed (e.g., when a user selects a new channel). Processing circuitry 108 may also analyze a range or a discrete set of power levels and select a different IF in response to a change of environmental or other conditions such as an amount of interference in a current target channel exceeding a threshold level. Processing circuitry 108 may further analyze a range or a discrete set of power levels and select a different IF in response to a user input indicating that the reception of the target channel has interference.

Processing circuitry 108 may store an IF corresponding to a lowest power image for each target channel for later use. These IFs may be stored during manufacturing or calibration of receiver 100B or in response to a one time or periodic calibration in normal operation by a user. Processing circuitry 108 may select the stored IF when a target channel is selected.

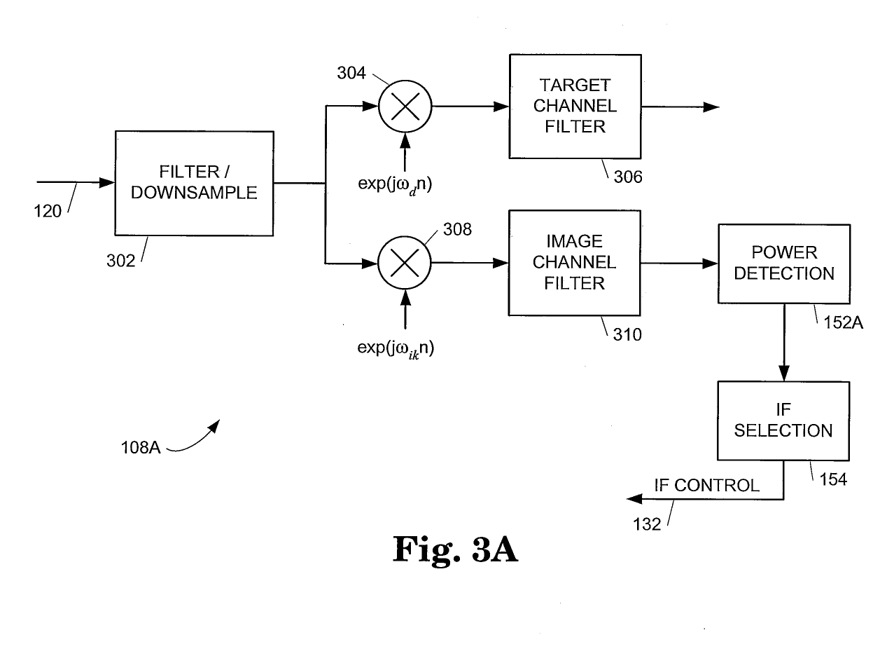

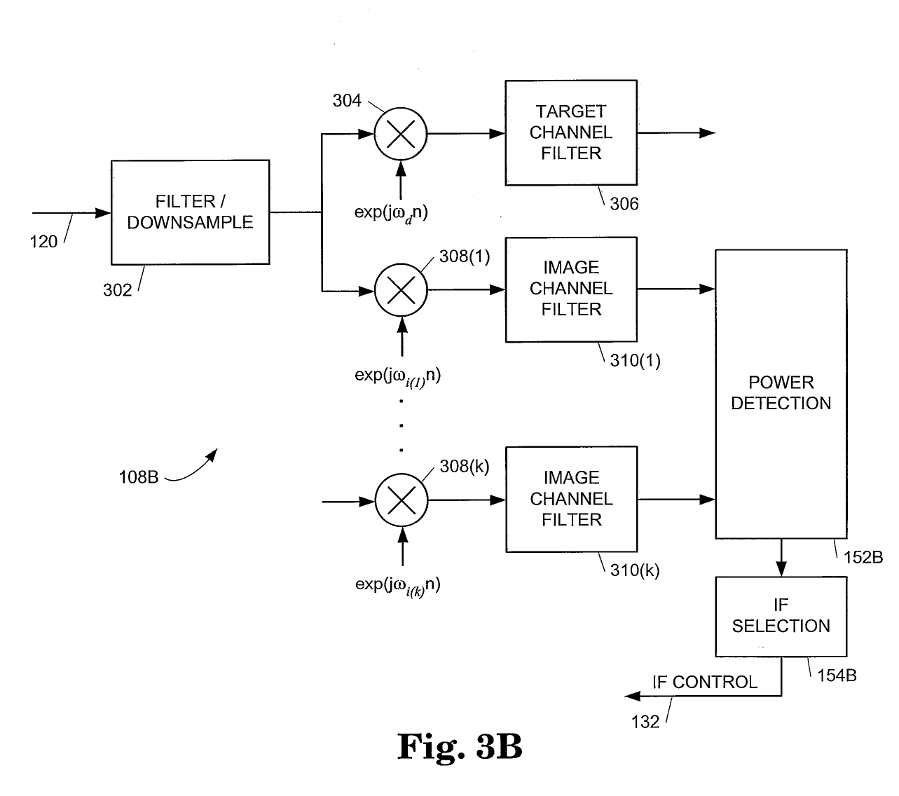

Power detection unit 152 may determine the power levels of each possible image in any suitable way. In one embodiment, mixed signal 120 are mixed down to DC for each possible image frequency and power detection unit 152 may measure the average DC power to determine each power level as described below in the embodiments of FIGS. 3A and 3B. In other embodiments, other transformations of mixed signal 120 may be performed or power detection unit 152 may use other algorithms to determine the power levels of possible images. These algorithms may include a Goetzel algorithm, for example.

Power detection unit 152 may determine the power levels of possible images in parallel with the processing of target channel in processing circuitry 108, as shown in the embodiments of FIGS. 3A and 3B, or prior or subsequent to the processing of target channel in processing circuitry 108.

FIG. 3A is a block diagram illustrating one embodiment of selected portions of an embodiment 108A of processing circuitry 108 in low-IF receiver 100B. In the embodiment of FIG. 3A, processing circuitry 108A includes a filter/downsample unit 302 configured to filter and downsample signals 120 and provide the filtered and downsampled signals to mixers 304 and 308. Mixer 304 mixes the signals from filter/downsample unit 302 with a mixing signal with a frequency of ω_{d} to mix the target channel down to DC and provides the mixed signal to a target channel filter unit 306 to filter the mixed signal.

In parallel with the operation of mixer 304 and target channel filter unit 306, mixer 308 mixes the signals from filter/downsample unit 302 with a mixing signal with a frequency of ωᵢₖ, where k is an index that denotes the kth possible image frequency, to mix a possible image frequency of the target channel down to DC. Mixer 308 provides the mixed signal to an image channel filter unit 310 to filter the mixed signal. An embodiment 152A of power detection unit 152 receives the filtered image signal from image channel filter unit 310 and determines a power level of the image at the possible image frequency. The process repeats to determine the power level for each possible image frequency 1 through k.

Subsequent to sequentially determining the power level for the possible image frequencies, power detection unit 152A determines the image frequency with the lowest power and notifies IF selection unit 154. IF selection unit 154 generates IF CONTROL signal 132 and provides signal 132 to LO generation circuitry 130 to cause the frequency of mixing signal 118, f_{LO}, to be set to select the IF.

FIG. 3B is a block diagram illustrating one embodiment of selected portions of an embodiment 108B of processing circuitry 108 in low-IF receiver 100B. In the embodiment of FIG. 3B, processing circuitry 108B processes the target channel similar to as processing circuitry 108A as described above with reference to FIG. 3A using filter/downsample unit 302, mixers 304, and target channel filter unit 306.

Processing circuitry 100B includes a set of mixers 308(1)-308(k) that each mix the signals from filter/downsample unit 302 with respective mixing signals with respective frequencies of ωᵢ₍₁₎-ωᵢ₍ₖ₎ to mix possible image frequencies of the target channel down to DC in parallel. The mixed signals from mixers 308(1)-308(k) are provided to image channel filter units 310(1)-310(k), respectively, to filter the mixed signals. An embodiment 152B of power detection unit 152 receives the filtered image signals from image channel filter units 310(1)-310(k) and determines power levels of the images at the possible image frequencies. Power detection unit 152B determines the image frequency with the lowest power and notifies IF selection unit 154. IF selection unit 154 generates IF CONTROL signal 132 and provides signal 132 to LO generation circuitry 130 to cause the frequency of mixing signal 118, f_{LO}, to be set to select the IF. Mixers 308(1)-308(k) and image channel filter units 310(1)-310(k) operate in parallel with the operation of mixer 304 and target channel filter unit 306.

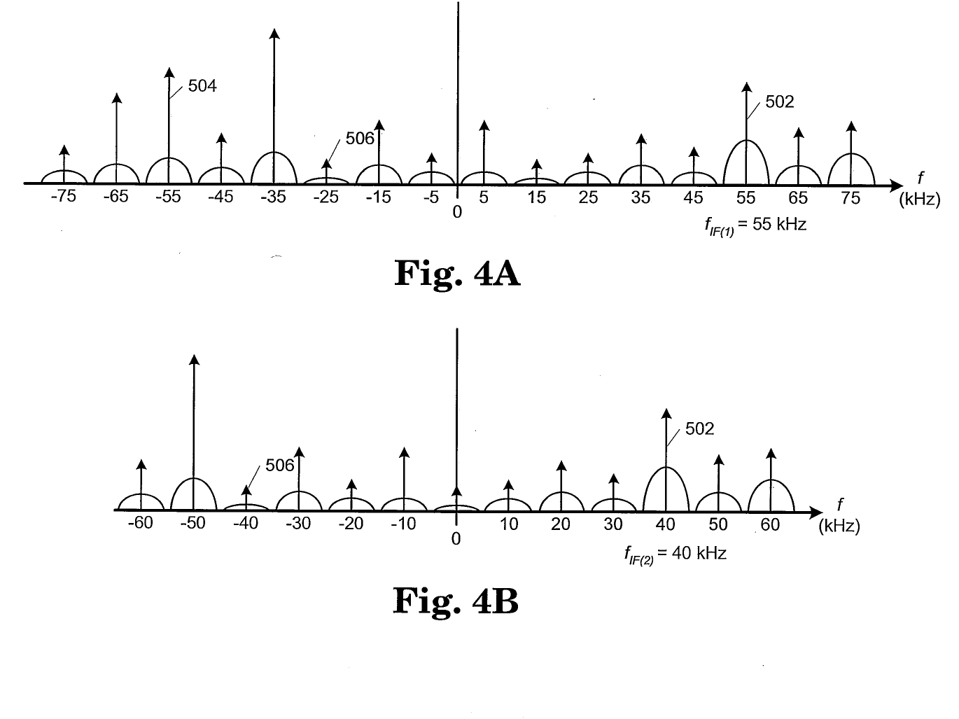

FIGS. 4A-4B are graphical diagrams illustrating an example of setting an intermediate frequency in low-IF receiver 100B. In the example of FIG. 4A, the channel spacing is 10 kHz, the integer multiple, M, is set to 11, and the initial IF, f_{IF(1)}, of the target channel is 55 kHz as indicated by an arrow 502 so that the image occurs at −55 kHz as indicated by an arrow 504.

By analyzing the signal power at −65, −55, −45, −35, and −25 kHz (e.g., serially or in parallel), power detection unit 152 determines that the image at −55 kHz has significantly more power than a possible image at −25 kHz as indicated by an arrow 506. Accordingly, IF selection unit 154 changes the integer multiple, M, to 8 to correspond to the image at −25 kHz. As a result, the spectrum shown in FIG. 4A changes to the spectrum shown in FIG. 4B such that the new IF, f_{IF(2)}, of the target channel is 40 kHz as indicated by arrow 502 in FIG. 4B and the image that was at −25 kHz in when the integer multiple, M, was 8 in FIG. 4A becomes the lower power image at −40 kHz as indicated by arrow 506 in FIG. 4B.

FIG. 1C is a block diagram illustrating an embodiment 100C of low-IF receiver 100. Receiver 100C forms an integrated terrestrial broadcast that is configured to receive FM and AM broadcasts. Receiver 100C includes an FM antenna 111 that provides a differential FM input signal, FMI, between antenna 111 and a ground connection, RFGND, 113, to an LNA 102A. Receiver 100C also includes an AM antenna 115 that provides a differential AM input signal, AMI, between antenna 115 and ground connection, RFGND, 113, to an LNA 102B. AM antenna 115 is a ferrite bar antenna, and the AM reception can be tuned using an on-chip variable capacitor circuit 144. FM antenna 111 reception may also be tuned with an on-chip variable capacitor circuit (not shown), if desired. An integrated supply regulator (LDO) block 188 regulates the on-chip power using a supply voltage, VDD (2.7-5.5 V), from a power supply 192 across a capacitor 194.

LNAs 102A and 102B operate in conjunction with automatic gain control (AGC) blocks 162A and 162B, respectively, and provide output signals to mixers 104A and 104B, respectively. Mixers 104A and 104B process the respective signals and each generate real (I) and an imaginary (Q) signals. Mixers 104A and 104B each provide the real (I) and an imaginary (Q) signals to a programmable gain amplifier (PGA) 164. Receiver 100C operates such that only one of mixers 104A and 104B provides signals to PGA 164 at a time. PGA 164 processes the signals from mixers 104A and 104B to generate output signals. The output signals from PGA 164 are then converted to digital I and Q values with I-path ADC 146 and Q-path ADC 148.

Processing circuitry 108 then processes the digital I and Q values to produce left (L) and right (R) digital audio output signals and provides the digital audio output signals to digital audio block 194. Digital audio block 194 provides the digital audio output signals (DOUT) to controller 190 and communicates with controller 190 using a DFS signal. Power detection unit 152 and IF selection unit 154 in processing circuitry 108 operate as described above with reference to FIG. 1B to generate IF selection signal 132.

In addition, these left (L) and right (R) digital audio output signals are processed by DAC circuits 124 and 126 to produce left (LOUT) and right (ROUT) analog output signals. These analog output signals are output to listening devices, such as headphones or speakers. Amplifier 166 and speaker outputs 168A and 168B, for example, may represent headphones or speakers for listening to the analog audio output signals. As described above, processing circuitry 108 provides a variety of processing features, including digital filtering, FM and AM demodulation (DEMOD) and stereo/audio decoding, such as MPX decoding. Low-IF block 180 includes additional circuitry utilized to control the operation of processing circuitry 108 in processing the digital I/Q signals.

Receiver 100C also includes a digital control interface 186 to communicate with external devices, such as controller 190. The digital communication interface between control interface 186 and controller 190 includes a bi-directional GPO signal, a VIO signal, a bi-directional serial data input/output (SDIO) signal, a serial clock input (SCLK) signal, and a serial interface enable (SEN_) input signal. In addition, control and/or data information is provided through interface 186 to and from external devices, such as controller 192. For example, a RDS/RBDS block 182 reports relevant RDS/RBDS data through control interface 186. A receive signal strength indicator block (RSSI) 184 analyzes the received signal and reports data concerning the strength of the signal through control interface 186. In other embodiments, other communication interfaces may be used, if desired, including serial or parallel interfaces that use synchronous or asynchronous communication protocols.

An external oscillator 176, operating, for example, at 32.768 kHz, provides a fixed reference clock signal to a tune block 174 through an RCLK connection. Tune block 174 also receives a DCLK signal 178. Tune block 174 generates a reference frequency according to IF control signal 132 from processing circuitry 108, as described above with reference to FIGS. 1A and 1B, and provides the reference frequency to a frequency synthesizer 172. An automatic frequency control (AFC) block 170 receives a tuning error signal from the receive path circuitry within receiver 100C and provide a correction control signal to frequency synthesizer 172.

Frequency synthesizer 172 receives the reference frequency from tuning block 174 and the correction control signal from AFC block 170. Frequency synthesizer 172 generates two mixing signals that are 90 degrees out of phase with each other and provides the mixing signals to mixers 104A and 104B as signals 118A and 118B, respectively.

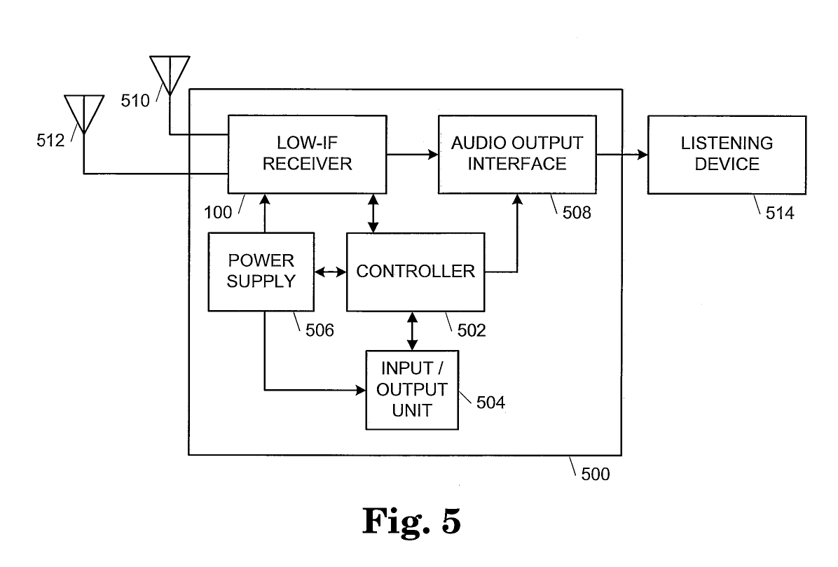

FIG. 5 is a block diagram illustrating one embodiment of a device 500 that includes low-IF receiver 100. Device 500 may be any type of portable or non-portable electronic device such as a mobile or cellular telephone, a personal digital assistant (PDA), an audio and/or video player (e.g., an MP3 or DVD player), an audio and/or video system (e.g., a television or stereo system), a wireless telephone, a desktop or laptop computer, or a peripheral card (e.g., a USB card) that couples to a computer. Device 500 includes low-IF receiver 100, a controller 502, an input/output unit 504, a power supply 506, an audio output interface 508, an FM antenna 510, an AM antenna 512, and a listening device 514, among other components.

Low-IF receiver 100 receives broadcast signals using antenna 510 and antenna 512, processes the signals as described above, provides digital audio signals to controller 502, and provides analog audio signals to audio output interface 508. Low-IF receiver 100 selects a broadcast channel in response to channel selection inputs from controller 502.

Controller 502 provides channel selection inputs and other control inputs to low-IF receiver 100. Controller 502 receives the digital audio signals from low-IF receiver 100, processes the digital audio signals, and provides the processed signals in a digital or audio format to audio output interface 508. Controller 502 may provide control inputs to audio output interface 508 to select the audio signals that are output by audio output interface 508.

Input/output unit 504 receives information from a user and provides the information to controller 502. Input/output unit 504 also receives information from controller 502 and provides the information to a user. The information may include channel selection information, voice and/or data communications, audio, video, image, or other graphical information. Input/output unit 504 includes any number and types of input and/or output devices to allow a user provide information to and receive information from device 500. Examples of input and output devices include a microphone, a speaker, a keypad, a pointing or selecting device, and a display device.

Power supply 506 provides power to low-IF receiver 100, controller 502, input/output unit 504, and audio output interface 508. Power supply 506 includes any suitable portable or non-portable power supply such as a battery or an AC plug.

Audio output interface 508 provides at least one digital or analog audio signal stream to listening device 514. Listening device 514 broadcasts the audio signal to a user. Listening device 514 may be any suitable audio broadcast device such as headphones or speakers. Listening device 514 may also include an amplifier or other audio signal processing devices.

In the above embodiments, at least LO generation circuitry 130, mixer 104, low-IF conversion circuitry 106 and processing circuitry 108 may be located on-chip and integrated on the same integrated circuit (i.e., on a single chip that is formed on a common substrate). In addition, LNA 102, LNA 102A, and LNA 102B and other desired circuitry may also be integrated into the same integrated circuit. An antenna that couples to LNAs 102, 102A, or 102B (such as antennas 111 and 115 in FIG. 1C or antennas 510 and 512 in FIG. 5) may be located off-chip (i.e., external to the common substrate that includes receiver 100). In other embodiments, other components of receiver 100 may be located off-chip.

In the above embodiments, a variety of circuit and process technologies and materials may be used to implement the receivers described above. Examples of such technologies include metal oxide semiconductor (MOS), p-type MOS (PMOS), n-type MOS (NMOS), complementary MOS (CMOS), silicon-germanium (SiGe), gallium-arsenide (GaAs), silicon-on-insulator (SOI), bipolar junction transistors (BJTs), and a combination of BJTs and CMOS (BiCMOS).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A receiver comprising:
a mixer configured to generate a mixed signal at a first intermediate frequency from an input signal and a mixing signal; and
processing circuitry configured to detect a power level for each of a plurality of possible images in the mixed signal and configured to cause the mixer to generate the mixed signal at a second intermediate frequency that differs from the first intermediate frequency and corresponds to an image frequency of one of the plurality of possible images with a lowest of the power level.

2. The receiver of claim 1 wherein the second intermediate frequency is equal to a difference between the mixing signal and the input signal.

3. The receiver of claim 1 further comprising:
a local oscillator configured to generate the mixing signal.

4. The receiver of claim 3 wherein the processing circuitry is configured to cause the local oscillator to generate the mixing signal at a mixing frequency that is offset from the image frequency by the second intermediate frequency.

5. The receiver of claim 1 wherein the processing circuitry configured to serially tune to the image frequencies of each of the plurality of possible images to detect the power levels.

6. The receiver of claim 1 wherein the processing circuitry configured to tune to the image frequencies of each of the plurality of possible images in parallel to detect the power levels.

7. The receiver of claim 1 wherein the processing circuitry configured to tune to the image frequencies of each of the plurality of possible images to detect the power levels in parallel with tuning to a target frequency of a target channel.

8. The receiver of claim 1 wherein the first intermediate frequency is equal to one half of a first integer multiple of a channel spacing of a plurality of broadcast frequencies in the input signal, and the wherein the second intermediate frequency is equal to one half of a second integer multiple of the channel spacing.

9. The receiver of claim 1 further comprising:
analog-to-digital conversion circuitry configured to convert the mixed signal to a digital signal and provide the digital signal to the processing circuitry;
wherein the processing circuitry is configured to detect the power level for each of the plurality of possible images using the digital signal.

10. The receiver of claim 1 wherein the input signal includes an RF signal spectrum with a plurality of AM channels.

11. A method performed by a low intermediate frequency receiver, the method comprising:
determining a first power level of a first image in a mixed signal having a first intermediate frequency; and
selecting a second intermediate frequency for the mixed signal in response to the first power level exceeding a desired power level.

12. The method of claim 11 further comprising:
setting a mixing frequency of a mixing signal that is used generate the mixed signal at the second intermediate frequency.

13. The method of claim 11 further comprising:
determining a second power level of a second image in the received signal, the second image at a second image frequency that corresponds to a second intermediate frequency; and
selecting the second intermediate frequency in response to the first power level exceeding the second power level.

14. The method of claim 11 wherein the first intermediate frequency is equal to one half of a first integer multiple of a channel spacing of a received signal used to generate the mixed signal, and wherein the second intermediate frequency is equal to one half of a second integer multiple of the channel spacing.

15. The method of claim 14 wherein the channel spacing is one of 9 kHz and 10 kHz.

16. The method of claim 11 further comprising:
generating the mixed signal at the second intermediate frequency by mixing an input signal having an AM broadcast frequency with a mixing signal.

17. A system comprising:
means for detecting a first power level of a first image in a mixed signal generated from an input signal and a mixing signal, the first image corresponding to a first intermediate frequency of the mixed signal; and
means for changing the mixed signal to a second intermediate frequency that differs from the first intermediate frequency in response to the first power level exceeding a threshold level.

18. The system of claim 17 further comprising:
means for detecting a second power level of a second image in the mixed signal, the second image corresponding to the second intermediate frequency of the mixed signal.

19. The system of claim 17 wherein the first intermediate frequency is equal to one half of a first integer multiple of a channel spacing of a plurality of broadcast frequencies in the input signal, and the wherein the second intermediate frequency is equal to one half of a second integer multiple of the channel spacing.

20. The system of claim 17 further comprising:
means for generating the mixed signal from the input signal and the mixing signal.

21. The system of claim 17 further comprising:
means for converting the mixed signal to a digital signal, the means for converting having a bandwidth that includes the first intermediate frequency and the second intermediate frequency.

22. A system comprising:
an audio output interface configured to provide an output signal to a listening device; and
a receiver including:
a mixer configured to generate a mixed signal at a first intermediate frequency from an input signal and a mixing signal; and
processing circuitry configured to detect a power level for each of a plurality of possible images in the mixed signal and configured to cause the mixer to generate the mixed signal at a second intermediate frequency that differs from the first intermediate frequency and corresponds to an image frequency of one of the plurality of possible images with a lowest of the power level;
wherein the receiver is configured to generate the output signal from a target channel in the mixed signal and provide the output signal to the audio output interface.

23. The system of claim 22 further comprising:
an input/output unit configured to provide a channel selection to the receiver that identifies the target channel;
wherein the processing circuitry is configured to detect the power level for each of the plurality of possible images in the mixed signal in response to receiving the channel selection from the input/output unit.

24. The system of claim 22 further comprising:
the listening device configured to broadcast the output signal.

25. The system of claim 22 wherein the first intermediate frequency is equal to one half of a first integer multiple of a channel spacing of a plurality of broadcast frequencies in the input signal, and the wherein the second intermediate frequency is equal to one half of a second integer multiple of the channel spacing.

26. The system of claim 22 wherein the target channel includes an AM broadcast channel.
